(19) United States
(12) Patent Application Publication
(10) Pub. No.: US 2020/0204311 A1
(43) Pub. Date: Jun. 25, 2020

(54) METHOD AND APPARATUS FOR TRANSMITTING/RECEIVING DATA IN WIRELESS COMMUNICATION SYSTEM

(71) Applicant: Samsung Electronics Co., Ltd., Gyeonggi-do (KR)

(72) Inventors: Suha YOON, Gyeonggi-do (KR); Suyoung PARK, Gyeonggi-do (KR); Euichang JUNG, Seoul (KR); Sunghyuk SHIN, Gyeonggi-do (KR)

(21) Appl. No.: 16/645,985

(22) PCT Filed: Sep. 18, 2018
(86) PCT No.: PCT/KR2018/010986

§ 371 Date: Mar. 10, 2020

(30) Foreign Application Priority Data
Sep. 29, 2017 (KR) 10-2017-0127223

(51) Int. Cl. H04L 5/00; H04B 7/024

(52) U.S. Cl. CPC H04L 5/0035; H04L 5/0094; H04L 5/0007; H04B 7/024

(57) ABSTRACT

The present disclosure relates to an apparatus and a method for transmitting and receiving data in a wireless communication system. A method according to an embodiment of the present disclosure is a method for transmitting data to a terminal by two or more transmission points belonging to one base station, in which the respective transmission points may perform the operations of: allocating a first resource for transmitting identical data to the terminal; configuring first control information for reconstructing the first resource; and transmitting the first control information, first additional information, and the data to the terminal through an established beam pair link (BPL) to the terminal, wherein the first additional information includes resource information of information corresponding to the first control information transmitted by at least one other transmission point for transmitting the identical data.

### TECHNICAL FIELD

The disclosure relates to a method and apparatus for transmitting and receiving data in a wireless communication system.

### BACKGROUND ART

In order to satisfy wireless data traffic demands that tend to increase after 4G communication system commercialization, efforts to develop an enhanced 5G communication system or a pre-5G communication system are being made. For this reason, the 5G communication system or pre-5G communication system is called a beyond 4G network communication system or a post LTE system.

In order to achieve a high data transfer rate, the 5G communication system is considered to be implemented in a mmWave band (e.g., 60 GHz band). In order to reduce a loss of electric waves and increase the transfer distance of electric waves in the mmWave band, beamforming, massive MIMO, full dimensional MIMO (FD-MIMO), array antenna, analog beam-forming and large scale antenna technologies are being discussed in the 5G communication system.

Furthermore, in order to improve the network of a system, technologies, such as an improved small cell, an advanced small cell, a cloud radio access network (cloud RAN), an ultra-dense network, device to device communication (D2D), wireless backhaul, a moving network, cooperative communication, coordinated multi-points (CoMP) and reception interference cancellation, are being developed in the 5G communication system.

In addition, hybrid FSK and QAM modulation (FQAM) and sliding window superposition coding (SWSC) that are advanced coding modulation (ACM) schemes, improved filter bank multi-carrier (FBMC), non-quadrature multiple access (NOMA) and sparse code multiple access (SCMA) are being developed in the 5G system.

In 5G communication systems being discussed in various aspects as described above, several requirements are being discussed. There is a need for a data transmission and reception method suitable for such requirements and an apparatus therefor.

### DISCLOSURE OF INVENTION

### Technical Problem

Accordingly, the disclosure provides a data transmission and reception method suitable for contents necessary for a 5G communication system and an apparatus therefor.

Furthermore, the disclosure provides a method for a base station to robustly transmitting data and a base station apparatus capable of providing the method.

Furthermore, the disclosure provides a method for a UE to robustly transmitting data and a terminal apparatus capable of providing the method.

### Solution to Problem

A method according to an embodiment of the disclosure is a method for transmitting data from two or more transmission points under one base station to a terminal,

wherein each of the transmission points is configured to:

allocate a first resource for transmitting the same data to the terminal, configuring first control information for a restoration of the first resource, transmitting, to the terminal, the first control information, first additional information and the data through a beam pair link (BPL) set up with the terminal, and

wherein the first additional information may include resource information of information, transmitted by at least another transmission point transmitting the same data and corresponding to the first control information.

An apparatus according to an embodiment of the disclosure is a transmission point apparatus for transmitting data to a terminal. The apparatus includes a base station interface receiving, from a base station, data and a control signal to be provided to the terminal, a radio transceiver transmitting the data and the control signal to the terminal, and a transmission and reception point controller configured to allocate a first resource for transmitting the data to the terminal, configure first control information for a restoration of the first resource, and control the radio transceiver to transmit, to the terminal, the first control information, first additional information and the data through a beam pair link (BPL) set up with the terminal,

wherein the first additional information may include resource information of information, transmitted by at least another transmission point transmitting same data and corresponding to the first control information.

A method according to another embodiment of the disclosure is a method for receiving data from a first transmission point and a second transmission point under one base station. The method may include monitoring the reception of first control information and a first data channel through a beam pair link (BPL) set up with the first transmission point, monitoring the reception of second control information and a second data channel through a BPL set up with the second transmission point, identifying whether the second control information is received, detecting the second control information using the first information based on the second control information being not received, and demodulating and decoding received data based on information received in the first data channel and the second data channel,

wherein the first control information may include resource information of the second control information transmitted by the at least second transmission point.

An apparatus according to another embodiment of the disclosure is a terminal apparatus for receiving data from two or more transmission points. The terminal apparatus may include a transceiver receiving a first control signal and a first data channel through a beam pair link (BPL) set up with a first transmission point and receiving a second control signal and a second data channel through a beam pair link (BPL) set up with a second transmission point, and a controller configured to monitor the reception of the first control information and first data channel and the second control information and second data channel received from the transceiver, identify whether the second control information is received, detect the second control information using the first information based on the second control information being not received, and control the demodulation and decoding of data received in the first data channel and the second data channel through the transceiver,

wherein the first control information may include resource information of the second control information transmitted by the at least second transmission point.

A method according to another embodiment of the disclosure is a method for a base station to transmit data from two or more transmission points under the control of the base station to a terminal. The method may include configuring first control information for designating the location of a second control signal for the restoration of data in the transmission points, transmitting the first control signal to the terminal, and controlling each of the transmission points to transmit the second control signal and the data through a beam pair link (BPL) set up with the terminal.

### Advantageous Effects of Invention

According to the disclosure, data can be generated and transmitted so that a UE that receives data from a plurality of transmission and reception points can receive and restore the data although it does not receive a PDCCH transmitted in a BPL of a given transmission and reception point. Accordingly, the UE can robustly receive the data although it receives a PDCCH and PDSCH from at least one of the plurality of transmission and reception points.

### BRIEF DESCRIPTION OF DRAWINGS

FIG. 1 is a concept view in which data is transmitted to a UE through a plurality of transmission and reception points included in one base station.

FIG. 2A is a diagram illustrating a form in which the resources of a PDCCH and a PDSCH may be allocated in a 5G communication system. FIG. 2B is a diagram illustrating a form in which the resources of a PDCCH and a PDSCH may be allocated in a 5G communication system. FIG. 2C is a diagram illustrating a form in which the resources of a PDCCH and a PDSCH may be allocated in a 5G communication system. FIG. 2D is a diagram illustrating a form in which the resources of a PDCCH and a PDSCH may be allocated in a 5G communication system.

FIG. 3 is a diagram illustrating the search spaces four BPLs according to an embodiment of the disclosure.

FIG. 4A is a diagram illustrating a case where the resource locations of PDCCHs transmitted between different BPLs are associated according to the disclosure. FIG. 4B is a diagram illustrating a case where the resource locations of PDCCHs transmitted between different BPLs are associated according to the disclosure.

FIG. 5 is a diagram illustrating the resource locations of PDCCHs transmitted between different BPLs according to an embodiment of the disclosure.

FIG. 6 is a diagram illustrating the resource locations of PDCCHs transmitted between different BPLs according to another embodiment of the disclosure.

FIG. 7 is an exemplary diagram for describing the mapping of an aggregation level and location information of a PDCCH according to an embodiment of the disclosure.

FIG. 8 is a diagram illustrating a downlink resource including a CORESET resource in one base station or transmission and reception point of a 5G communication system according to an embodiment of the disclosure.

FIG. 9A is an exemplary diagram in which a CORESET resource is divided in a bitmap form according to an embodiment of the disclosure. FIG. 9A is an exemplary diagram in which a CORESET resource is divided in a bitmap form according to an embodiment of the disclosure.

FIG. 10 is a control flowchart upon downlink transmission by each transmission and reception point and/or base station according to the disclosure.

FIG. 11 is a control flowchart when a UE receives a PDCCH and PDSCH from a plurality of transmission and reception points according to the disclosure.

FIG. 12 is a functional block diagram of a transmission and reception point according to the disclosure.

FIG. 13 is a major block diagram of a terminal apparatus according to an embodiment of the disclosure.

### MODE FOR THE INVENTION

Hereinafter, various embodiments are described in detail with reference to the accompanying drawings. It is to be noted that the same reference numerals are used throughout the drawings to refer to the same elements. Furthermore, it is to be noted that the accompanying drawings of the disclosure are provided to help understanding of the disclosure and the disclosure is not limited to a form or arrangement illustrated in the drawings of the disclosure. Furthermore, a detailed description of the known functions or elements that may make the gist of the disclosure vague is omitted. It is to be noted that in the following description, only parts necessary to understand operations according to various embodiments of the disclosure are described and a description of other parts is omitted in order to prevent the gist of the disclosure from becoming vague.

Today in a standard conference that provides a 5G communication rule, a discussion of a standard is in progress in the name of a new radio (NR) in a 3GPP group. In most of communication standard rules, such as 4G, in addition to the 5G communication rule, first, in order to transmit data from a base station (NB) to a user equipment (UE, terminal, mobile station), a resource allocated to transmit data to a given UE and various types of control information for transmitting the data are transmitted through a physical downlink control channel (PDCCH). Thereafter, the base station may transmit the data to the corresponding UE based on the resource and control information transmitted through the PDCCH.

In a 5G system, a standard by which data is transmitted and received using millimeter carrier waves (mmWave) using a higher frequency than a band occupied in the existing communication system is regulated. As described above, in the frequency of a higher band than the band occupied in the existing communication system, beam blocking may frequently occur. The reason for this is that in terms of the frequency, the frequency of a high band has strong straightness and refraction and diffraction are not performed. Accordingly, when a line of sight (LOS) between a base station and a UE or a similar form or a given obstacle instantly occurs between paths for transmission from a base station to a UE through beamforming, an obstacle may occur in data reception on the UE side. For example, there may be a case where a transmission and reception point and a UE may be blocked by another building due to a vehicle or the walking of a pedestrian or a user. In such a case, there may be a case where data reception is impossible in the UE.

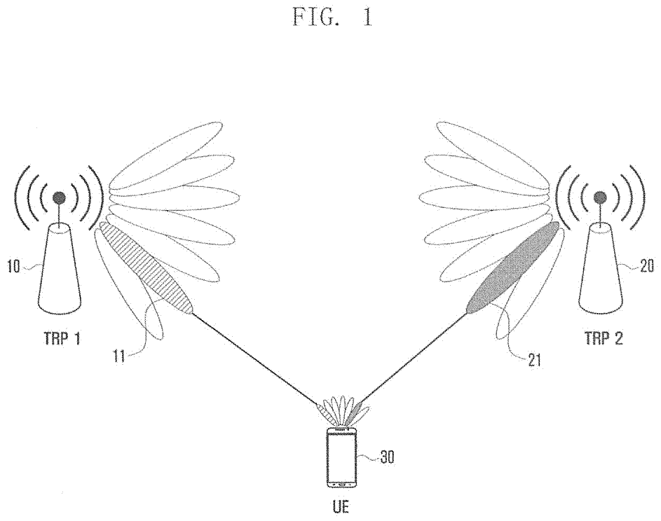

If a beam blocking phenomenon occurs between a base station and a UE as described above, several methods are proposed between the base station and the UE in order to robustly transmit data. This is described with reference to FIG. 1.

FIG. 1 is a concept view in which data is transmitted to a UE through a plurality of transmission and reception points included in one base station.

Referring to FIG. 1, two different transmission and reception points (TRPs) 10 and 20 controlled by one base station (NB) may be controlled by one base station (NB) or different base stations (not illustrated in FIG. 1). Hereinafter, for convenience of description, it is assumed and described that the first TRP 10 and the second TRP 20 are TRPs operating under the control of one base station.

The first TRP 10 may transmit data to a UE 30 through at least one beam 11 of a plurality of beams. Furthermore, the second TRP 20 may transmit data to the UE 30 through at least one beam 21 of a plurality of beams. In this case, the UE 30 may receive data from the first TRP 10 and/or the second TRP 20 using a plurality of beams.

In this case, each of the data transmitted from the first TRP 10 and the second TRP 20 to the given UE 30 through the beams 11 and 21 may include control data and user data. The control data may include at least one of a high layer signaling signal, an L1 signaling signal, system information, and a PDCCH, for example. Furthermore, the user data transmitted from each of the first TRP 10 and the second TRP 20 to the UE 30 through each of the beams 11 and 21 may be data processed in a given application.

In general, user data is transmitted from each of the first TRP 10 and the second TRP 20 to the UE 30 through each of the beams 11 and 21. The user data may be transmitted through a physical downlink shared channel (PDSCH). Furthermore, each of the first TRP 10 and the second TRP 20 may transmit, to the UE 30, control information for processing, such as resource allocation and the demodulation and decoding of the user data, through a PDCCH before it transmits the user data.

In the 5G system, an arrangement has been made so that if data is transmitted through a channel between one TRP, for example, the first TRP 10 and the UE 30 as described above, the same data is transmitted to the UE 30 through at least another TRP, that is, the second TRP 20, because the stability of data is insufficient.

Accordingly, the UE 30 in the 5G system needs to able to receive the same data from a plurality of TRPs in a given environment in which user data is received. If a plurality of different TRPs, for example, the first TRP 10 and the second TRP 20 transmits the same data to the same one UE 30 as described above, the base station needs to configure the number of beams that needs to be monitored by the UE 30. Accordingly, the UE 30 needs to be previously aware of beam pair link (BPL) information in which the first TRP 10 and the second TRP 20 transmit the same data, for example, BPL information of the first beam 11 of the first TRP 10 and the first beam 21 of the second TRP 20. Such BPL information may be set as a plural number, such as 2, 3 or 4. In the disclosure, BPL information has been illustrated as being 2, 3 or 4, but may be set as a larger number, such as 5, 6 or 7 more than 4 if necessary or according to the definition of a standard rule.

As described above, each of the TRPs 10 and 20 may transmit the same user data to the same one UE 30. In this case, in each of the TRPs 10 and 20, the resource of a PDSCH allocated to transmit the user data to the UE 30 and the resource of a PDCCH for configuring the allocated resource may be different. That is, a PDCCH orthogonal frequency division multiplexing (OFDM) symbol and/or a PDSCH OFDM symbol transmitted by the first TRP 10 and a PDCCH OFDM symbol and/or a PDSCH OFDM symbol transmitted by the second TRP 20 may be different.

Accordingly, the UE 30 needs to receive the PDCCH, transmitted by the first TRP 10, in order to receive the PDSCH from the first TRP 10 and provide it to a user. Furthermore, the UE 30 needs to receive the PDCCH transmitted by the second TRP 20 in order to receive the PDSCH from the second TRP 20 and provide it to the user. That is, the UE 30 needs to monitor the PDCCHs from the first TRP 10 and the second TRP 20 based on BPL information configured by the base station.

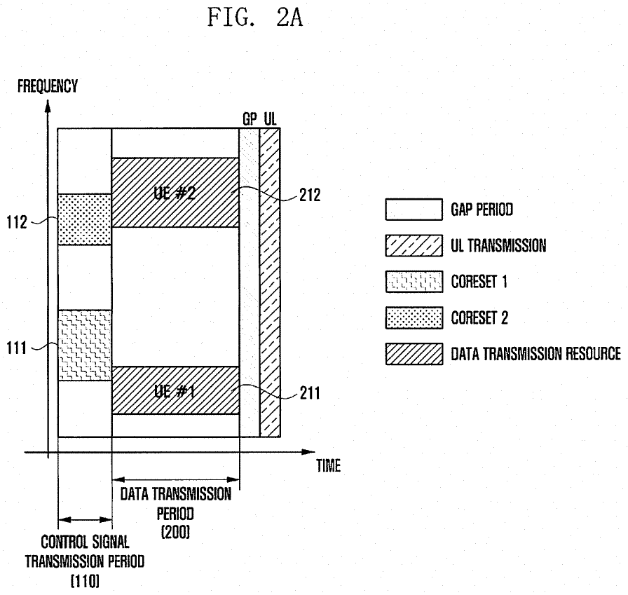

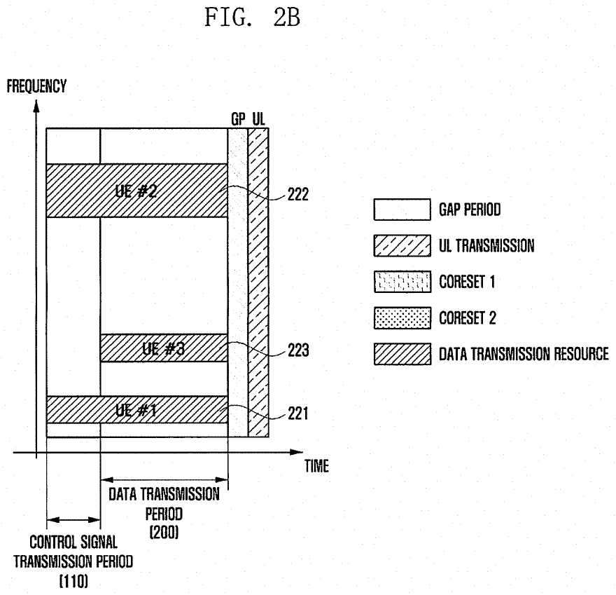

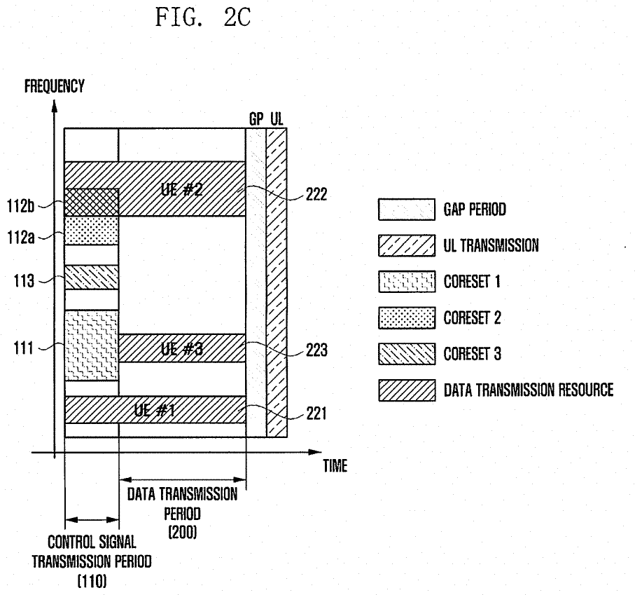

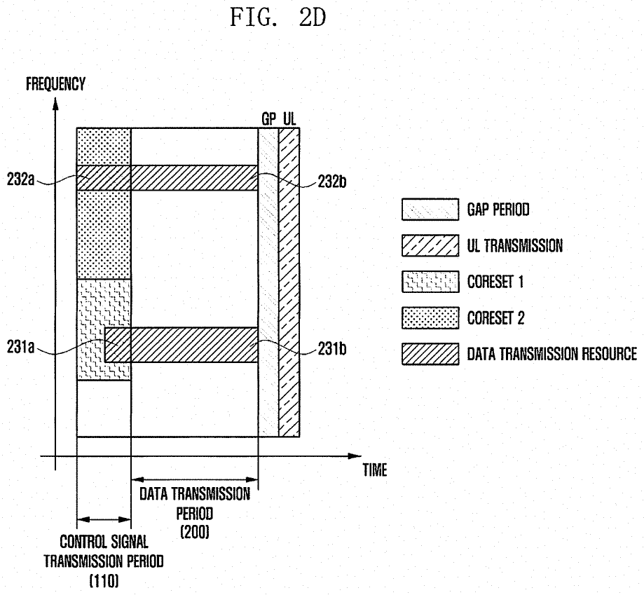

FIGS. 2A to 2D are diagrams illustrating forms in which the resources of a PDCCH and a PDSCH may be allocated in a 5G communication system.

First, referring to FIG. 2A, as in a previous 3G communication system and 4G communication system, resources may be divided into a time resource and frequency resource. That is, a given time region in a time axis may be configured as a control signal transmission period 110, and a subsequent period may be configured as a data transmission period 200. Accordingly, a base station and/or a TRP may transmit a PDCCH and a PDSCH using the time resource and frequency resource. Furthermore, in FIG. 2A, a GP corresponds to a guard period (GP), and subsequently, an uplink (UL) period has been illustrated. In the disclosure, a detailed description of the GP and UL is omitted.

Furthermore, in general, control resource sets (Control Resource set 1, Control Resource set 2) 111 and 112 may be transmitted in the control signal transmission period 110. Each of the control resource sets 111 and 112 may include resource allocation information of given user data and various types of control information for data restoration. The various types of control information for data restoration may include HARQ information, modulation and coding rate information, etc. and may further include other pieces of widely-known control information.

Unlike in the existing 4G system, a very wide frequency band and a high frequency band are used in a 5G system. Accordingly, a PDCCH is not transmitted in all frequency bands as in FIG. 2A, but a given resource set for providing the PDCCH is configured. This is called a control resource set (CORESET). Accordingly, if FIG. 2A is applied to a 5G system, FIG. 2A may be a figure illustrating CORESETs.

After the control signal transmission period in FIG. 2A, there is a data transmission period, that is, a period in which a PDSCH is transmitted. FIG. 2A illustrates a case where in the PDSCH transmission period, a resource 211 for a UE #1 and a resource 212 for a UE #2 have been allocated. Accordingly, the UE #1 resource 211 may be indicated by a first control resource set 111, and the UE #2 resource 212 may be indicated by a second control resource set 112.

Unlike in the existing 4G communication system, in a 5G communication system, forward compatibility is a condition in order to consider future services to be provided in the future. Accordingly, in the 5G communication system, there has been proposed to transmit a PDSCH even in the control signal transmission period 110. This is described with reference to FIG. 2B.

Referring to FIG. 2B, the form may include a control signal transmission period 110 and a data transmission period 200 as described above. In this case, data may be transmitted only in the data transmission period 200 like a resource 223 allocated to a UE #3, but the form may be configured so that a PDSCH is transmitted even in the control signal transmission period 110 like a UE #1 resource 221 and a UE #2 resource 222.

As described above, a UE may recognize whether data is transmitted thereto through which PDSCH resource and a method for the restoration of data included in the PDSCH through only a PDCCH. Accordingly, the UE needs to receive the PDCC in order to properly restore the PDSCH. However, if a PDSCH resource is transmitted in a PDCCH region as in FIG. 2B, a region overlapping a PDCCH may occur. This is described with reference to FIG. 2C.

Referring to FIG. 2C, wireless communication resources may be illustrated as a time resource and a frequency resource as described above. Furthermore, if FIG. 2C is a 5G communication system, it includes the control signal transmission period 110, and thus a resource illustrated in FIG. 2C may be a resource including CORESETs.

Referring to FIG. 2C, a resource allocated to each UE and control information for the restoration of data may be transmitted in the control signal transmission period 110. It is assumed that in FIG. 2C, a first control resource set 111 indicates a UE #1 resource 221, a second control resource set 112 indicates a UE #2 resource 222, and a third control resource set 113 indicates a UE #3 resource 223.

Accordingly, the PDCCH of the first resource set 111 and the PDCCH of the third resource set 113 do not include a region overlapping any PDSCH. However, the PDCCH of the second resource set 112 includes a region overlapping a PDSCH, that is, the UE #2 resource 222. That is, accordingly, the PDCCH of the second resource set 112 may be divided into a portion the PDCCH 112a in which overlap does not occur and a portion of the PDCCH 112b in which overlap occurs. If an overlap portion occurs between a PDCCH and a PDSCH as described above, information of the PDCCH has priority. Accordingly, rate matching may be performed and a resource may be mapped to the resource region of the PDSCH that overlaps the PDCCH so that data is not transmitted in the resource region of the PDSCH.

A region in which overlap occurs between a PDCCH and a PDSCH as described above may occur in another form, as illustrated in FIG. 2D. That is, FIG. 2C illustrates a case where overlap occurs only in some PDSCH transmitted in the period of a PDCCH, but overlap may identically occur in all of PDSCHs transmitted in the period of the PDCCH as in FIG. 2D.

Referring to FIG. 2D, the data transmission period of a UE #1 may include a PDSCH period 231a transmitted in some of a PDCCH and 231b transmitted only in the PDSCH period. Furthermore, the data transmission period of a UE #2 may include a PDSCH period 232a transmitted in the period of a PDCCH and 232b transmitted only in the PDSCH period. Accordingly, in such a case, transmission needs to be performed by removing some of the data of the PDSCH or the PDCCH. In this case, in general, the data of the PDSCH may be removed because the PDCCH has higher data priority, and rate matching may be performed based on a corresponding size, and the data may be transmitted.

Accordingly, in such a case, data actually transmitted to each UE may be transmitted in the region of a PDSCH period. In contrast, the size of control information may be reduced by performing rate matching in the period of a PDCCH, and data may be mapped to all PDSCHs transmitted in the period of the PDCCH and may be transmitted.

The configuration of a downlink a data transmission and reception method in a 5G communication system have been described above with reference to FIGS. 2A to 2D.

However, as described above, there may be a case where a PDCCH is not received from a given TRP. That is, if a PDCCH is not received from a given TRP due to an instant obstacle or an instant channel change, a PDSCH cannot be received from the corresponding TRP.

In a 5G communication system, a PDSCH has been configured to transmit data using a plurality of different TRPs in order to more robustly transmit the data. If a PDCCH transmitted by a given TRP is not received, however, a PDSCH transmitted from the corresponding TRP to a UE cannot be received and processed by the UE. As a result, from the viewpoint of the communication system, unnecessary resources are wasted and an object of robustly transmitting data may not be satisfied.

That is, if a base station configures a UE to receive PDCCHs from a plurality of BPLs, the UE may receive a plurality of the configured PDCCHs. In this case, the PDCCHs may be PDCCHs from different TRPs, as described with reference to FIG. 1. In this case, if at least one of given PDCCHs is not received as described above, a PDSCH from a TRP that fails in the reception of the PDCCH cannot be received.

Accordingly, the disclosure provides a method and apparatus for a base station to configure a UE to receive PDCCHs from a plurality of BPLs and for a base station to transmit control information so that a UE can receive a PDSCH provided by the TRP of the PDCCH although the UE fails in the reception of at least one of a plurality of PDCCHs.

Furthermore, the disclosure provides a method and apparatus for a base station to configure a UE to receive PDCCHs from a plurality of BPLs and for a UE to receive a PDSCH from the TRP of a PDCCH although the UE fails in the reception of at least one of a plurality of PDCCHs.

Furthermore, the disclosure provides a method and apparatus for a base station to configure a UE to receive PDCCHs from a plurality of BPLs and for a base station to transmit control information so that a UE can receive a PDSCH transmitted by the remaining TRPs although the UE is successful in the reception of only at least one of a plurality of PDCCHs.

Furthermore, the disclosure provides a method and apparatus for a base station to configure a UE to receive PDCCHs from a plurality of BPLs and for a UE to receive a PDSCH transmitted by the remaining TRPs although the UE is successful in the reception of only at least one of a plurality of PDCCHs.

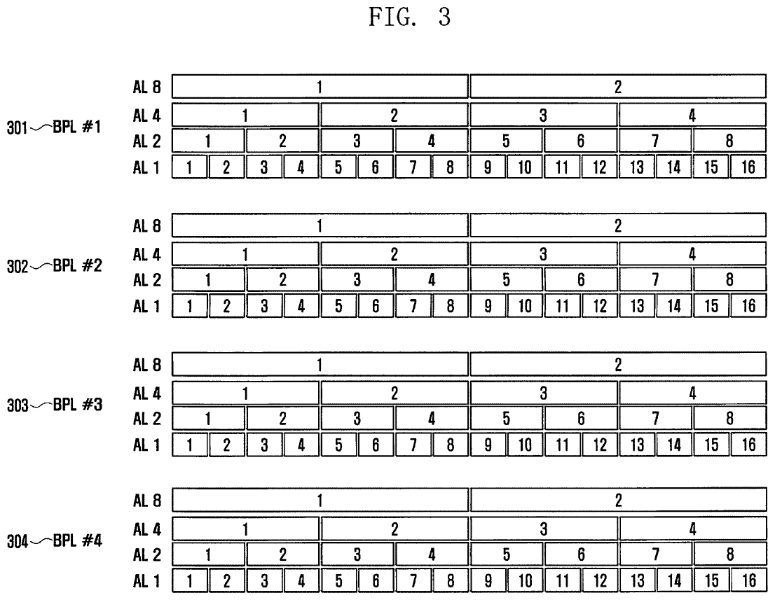

FIG. 3 is a diagram illustrating the search spaces four BPLs according to an embodiment of the disclosure.

Referring to FIG. 3, a BPL #1 301, a BPL #2 302, a BPL #3 303, and a BPL #4 304 have been illustrated as an example. Each of the BPL #1 301 to the BPL #4 304 may correspond to one TRP. It has been described above that a UE may monitor PDCCHs received from a plurality of TRPs. Accordingly, the example of FIG. 3 may be a case where the UE monitors a PDCCH from the 4 TRPs.

Furthermore, a base station and/or the TRPs may have an aggregation level in one resource element (RE) unit or in unit of a plurality of REs in a PDCCH transmitted in a CORESET. For example, if an aggregation level (AL) is 1, this is a case where transmission is performed through only one RE. That is, the case of the AL 1 may correspond to a case where an aggregation is not performed. The case of an AL 2 is a case where transmission is performed through two REs. In the case of an AL 4, transmission may be performed through 4 REs. In the case of an AL 8, transmission may be performed through 8 REs.

FIG. 3 is an exemplary diagram for describing that the search space may be transmitted through one RE or 2 REs or 4 REs or 8 Res in the BPL of each TRP.

This is described assuming the case of FIG. 1. It is assumed that the UE 30 receives data through BPLs 11 and 21 of the two TRPs 10 and 20, respectively. Furthermore, the BPL 11 of the first TRP 10 is assumed to be the BPL #1 301 of FIG. 3, and the BPL 21 of the second TRP 20 is assumed to be the BPL #2 302 of FIG. 3.

Accordingly, the UE 30 monitors the BPL 11 from the first TRP 10. In this case, the UE may recognize that a search space is present in a CORESET using one method of the AL 1, the AL 2, the AL 4 and the AL 8. In this case, the TRP and/or the base station may previously configure such AL information through system information or high signaling or may not configure this. If the TRP and/or the base station does not configure such AL information, the UE may perform blind detection. Such a method has been widely known, and is not additionally described.

In such a case, the following cases may occur when a PDCCH is transmitted. For example, the first TRP 10 may transmit a PDCCH at the No. 4 location of the AL 1 through the BPL 11. In such a case, the second TRP 20 may transmit a PDCCH at the No. 6 location of the AL 2 separately from the first TRP 10.

For another example, the first TRP 10 may transmit a PDCCH at the No. 2 location of the AL 8 through the BPL 11. In such a case, the second TRP 20 may transmit a PDCCH at the No. 2 location of the AL 4 separately from the first TRP 10. As described above, the resource allocation of a PDCCH may be independently performed in each TRP.

For yet another example, the first TRP 10 may transmit a PDCCH at the No. 2 location of the AL 1 through the BPL 11. In such a case, the second TRP 20 may transmit a PDCCH in the same location or a location based on a preset given rule with an association with the first TRP 10.

### First Embodiment

Accordingly, first, a case where the resource locations of PDCCHs between the BPLs of each base station and/or TRP has an association is described.

The location of a PDCCH transmitted in the BPL #1 301 in FIG. 3 may have been associated with the BPL #2 302, the BPL #3 303 and the BPL #4 304. That is, this is a method for the UE 30 to be aware of the location of the PDCCH of another BPL based on a rule obtained from one BPL when it receives a PDCCH in the one BPL.

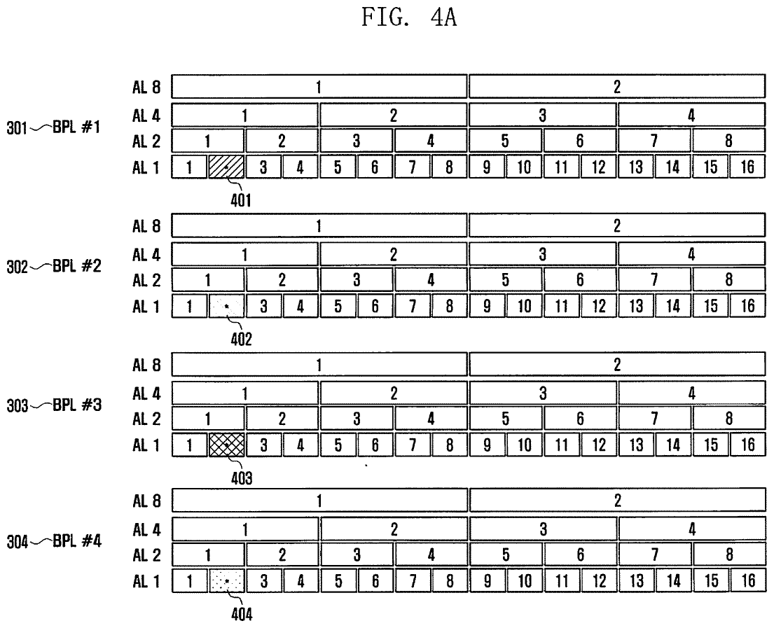

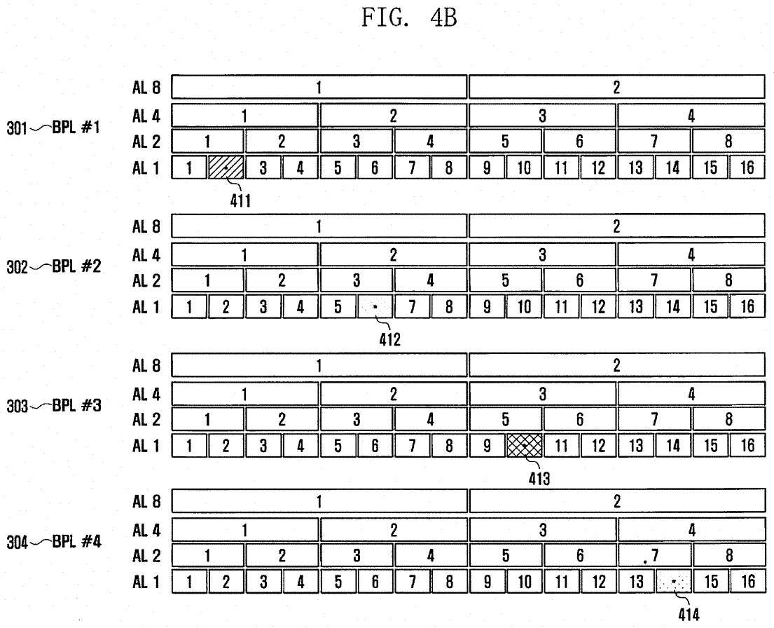

FIGS. 4A and 4B are diagrams illustrating cases where the resource locations of PDCCHs transmitted between different BPLs are associated according to the disclosure.

First, FIG. 4A is a case where each of BPLs 301, 302, 303, and 304 transmits a PDCCH, transmitted to a given UE, using the same location and the same AL within the search space of each TRP and/or base station.

As illustrated in FIG. 4A, if a PDCCH is transmitted at the No. 2 location 401 of an AL 1 in the BPL #1 301 of a first TRP, a second TRP transmits a PDCCH at the No. 2 location 402 of an AL 1 in the BPL #2 302, a third TRP transmits a PDCCH at the No. 2 location 403 of an AL 1 in the BPL #3 303, and a fourth TRP transmits a PDCCH at the No. 2 location 404 of an AL 1 in the BPL #4 304.

A base station may previously configure such information in a UE through high signaling or system information. Alternatively, such information may be set based on a standard rule. If PDCCHs of a plurality of TRPs have to be monitored, when the location of a PDCCH for one TRP is determined, the locations of PDCCHs of other TRPs may be configured to be determined as the same location.

Accordingly, the UE can obtain information of PDCCHs of different TRPs although it obtains only at least one PDCCH as described above. Accordingly, the UE can precisely recognize the transmission region of a PDSCH and the transmission location of a PDCCH.

Furthermore, if the UE obtains a PDCCH in at least one of a plurality of BPLs, the removal of interference attributable to a carrier received from an adjacent TRP can be facilitated. For example, there may be a case where a UE receives a PDCCH normally from the first TRP 10 and does not receive a PDCCH from the second TRP 20. In such a case, if a PDCCH is received at the same location from the second TRP 20, an influence attributable to interference from the second TRP 20 can be removed because the location where the PDCCH is received from the first TRP 10 and the location where the PDCCH is received from the second TRP 20 are the same.

Furthermore, the UE can obtain data transmitted to the UE by demodulating and decoding PDSCHs received from a plurality of TRPs that have received PDCCHs normally because the TRPs transmit the PDCCHs at the same AL and the same location. For example, if M TRPs transmit PDCCHs, a UE needs to monitor the PDCCHs from M BPLs. In this case, if only N PDCCHs smaller than M are received, the UE may demodulate and decode a PDSCH using the received N PDCCHs.

Another case where the resource locations of PDCCHs between the BRLs of each base station and/or TRP have an association is described with reference to FIG. 4B.

In the case of FIG. 4B, the same case as that of FIG. 4A is assumed. This is a case where only a transmission location in the BPL of each TRP is changed based on a predetermined rule. That is, if a PDCCH is transmitted at the No. 2 location 411 of an AL 1 in the BPL #1 301 of a first TRP, a second TRP transmits a PDCCH at the No. 6 location 412 of an AL 1 in a BPL #2 302, a third TRP transmits a PDCCH at the No. 7 location 413 of an AL 1 in a BPL #3 303, and a fourth TRP transmits a PDCCH at the No. 14 location 414 of an AL 1 in a BPL #4 304.

When FIGS. 4A and 4B are compared, it can be seen that the form of FIG. 4 is a form in which a location has been configured to be increased every 4 at the same AL. A base station may previously provide such a rule through high signaling or system information.

In FIGS. 4A and 4B, the case where ALs are the same has been illustrated, but ALs may be changed. For example, a rule may be configured so that if a PDCCH is transmitted at the No. 1 location of the AL 1 in the BPL #1 301 of the first TRP, the second TRP transmits a PDCCH at the No. 1 location of an AL 2 in the BPL #2 302, the third TRP transmits a PDCCH at the No. 1 location of an AL 4 in the BPL #3 303, and the fourth TRP transmits a PDCCH at the No. 1 location of an AL 8 in the BPL #4 304.

Accordingly, a UE can obtain information of PDCCHs of different TRPs although it obtains only at least one PDCCH using a rule preset as described above. Accordingly, the UE can precisely recognize the transmission region of a PDSCH and the transmission location of the PDCCH.

Furthermore, if a UE obtains a PDCCH in at least one of a plurality of BPLs, the removal of interference attributable to a carrier received from an adjacent TRP can be facilitated. For example, there may be a case where a UE receives a PDCCH normally from the first TRP 10 and does not receive a PDCCH from the second TRP 20. In such a case, if a PDCCH is received at a given location from the second TRP 20, the reception location of a PDCCH of the second TRP 20 can be aware based on a location where the PDCCH is received from the first TRP 10. Accordingly, an influence attributable to interference from the second TRP 20 can be removed.

Furthermore, if the UE receives a PDCCH normally from at least one of a plurality of TRPs, it can receive a PDSCH normally based on the received PDCCH. Accordingly, the UE can obtain received data by demodulating and decoding the PDSCH. For example, if M TRPs transmit PDCCHs, a UE need to monitor the PDCCHs from M BPLs. In this case, if only N PDCCHs smaller than M are received, the UE may receive a corresponding PDSCH using the received N PDCCHs, and may demodulate and decode the received PDSCH.

### Second Embodiment

In the above embodiment, a case where the transmission resources of PDCCHs are associated for each BPL has been described above. However, there may be a case where the transmission resources of PDCCHs are not associated for each BPL. Particularly, in the complexity aspect of a system and the flexibility aspect of resource allocation of a system, it may be more preferred to not associate the transmission resources of PDCCHs for each BPL. Accordingly, a second embodiment is a case where the transmission resources of PDCCHs are not associated for each BPL.

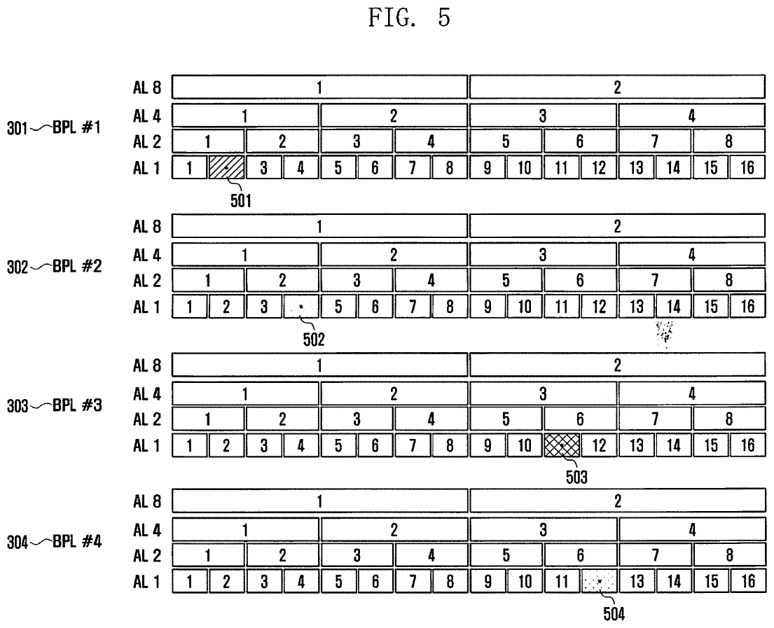

In this case, the meaning that the transmission resources of PDCCHs are not associated for each BPL means that the location of a PDCCH of another BPL cannot be aware although the PDCCH location of one BPL and/or high layer signaling is used. This is described with reference to FIG. 5.

FIG. 5 is a diagram illustrating the resource locations of PDCCHs transmitted between different BPLs according to an embodiment of the disclosure.

FIG. 5 illustrates a case where a first TRP transmits a PDCCH at the No. 2 location 501 of an AL 1 in a BPL #1 301, a second TRP transmits a PDCCH at the No. 4 location 502 of an AL 1 in a BPL #2 302, a third TRP transmits a PDCCH at the No. 11 location 503 of an AL 1 in a BPL #3 303, and a fourth TRP transmits a PDCCH at the No. 12 location 504 of an AL 1 in a BPL #4 304.

The example of FIG. 5 is a case where all the ALs of the first TRP to the fourth TRP are 1, but is a case where a case where a PDCCH is transmitted without a rule for transmitting the PDCCH is assumed as an example. In such a case, a UE cannot be aware at which location a corresponding TRP transmits a PDCCH if the UE does not receive a PDCCH from at least one of the first TRP to the fourth TRP.

Accordingly, in the disclosure, location information in another TRP may be configured in each PDCCH transmitted in each TRP. For example, in the BPL #1 301 of the first TRP, a PDCCH is transmitted at the No. 2 location 501 of the AL 1. In this case, the PDCCH may be transmitted, including location information of PDCCHs transmitted in the BPLs of other TRPs, that is, location information of a PDCCH transmitted in the BPL of the second TRP, location information of a PDCCH transmitted in the BPL of the third TRP, and location information of a PDCCH transmitted in the BPL of the fourth TRP.

That is, in the embodiment of FIG. 5, location information in which a PDCCH is transmitted by another TRP has only to be transmitted because all the AL of the first TRP to the fourth TRP are the same. Accordingly, only resource allocation information of a PDSCH and information for demodulation and decoding have been transmitted in previous PDCCH. In the disclosure, however, resource information of a PDCCH transmitted in another TRP is additionally transmitted.

This is described more specifically. In a conventional technology, assuming that information transmitted for the resource allocation and demodulation and decoding of a PDSCH in a PDCCH is default control information, in the disclosure, additional control information for designating the PDCCH location of another TRP is further transmitted.

For example, the PDCCH of the first TRP may include default control information for a PDSCH transmitted by the first TRP, and PDCCH location information (No. 4 location) of the second TRP, PDCCH location information (No. 11 location) of the third TRP, and PDCCH location information (No. 12 location) of the fourth TRP as additional information. Furthermore, the PDCCH of the second TRP may include default control information for a PDSCH transmitted at the second TRP, and PDCCH location information (No. 2 location) of the first TRP, PDCCH location information (No. 11 location) of the third TRP, and PDCCH location information (No. 12 location) of the fourth TRP as additional information. In the same manner, the PDCCH of the third TRP may include default control information for a PDSCH transmitted at the third TRP, and PDCCH location information (No. 2 location) of the first TRP, PDCCH location information (No. 4 location) of the second TRP, and PDCCH location information (No. 12 location) of the fourth TRP as additional information. Furthermore, the PDCCH of the fourth TRP may include default control information for a PDSCH transmitted at the fourth TRP, and PDCCH location information (No. 2 location) of the first TRP, PDCCH location information (No. 4 location) of the second TRP, and PDCCH location information (No. 11 location) of the third TRP as additional information.

As described above, the additional information may further include additional information for designating PDCCH locations having a number 1 smaller than the number of BPLs to be monitored by a UE. Accordingly, if a UE has to monitor 2 BPLs, additional information included in each PDCCH may be location information of one PDCCH.

Furthermore, in the example, separate identification information for identifying each TRP may be further included. That is, the first TRP may include identification information of the second TRP along with PDCCH location information of the second TRP. Accordingly, a UE that receives the same data from three or more TRPs can identify each of the TRPs, and can be aware of location information of a PDCCH of the identified TRP.

If a UE obtains a PDCCH in at least one of a plurality of BPLs using the aforementioned method, interference attributable to a carrier received from an adjacent TRP can be easily removed. For example, there may be a case where a UE receives a PDCCH normally from the first TRP 10 and does not receive a PDCCH from the second TRP 20. In such a case, the UE can be aware of the location of the PDCCH received from the second TRP 20. Accordingly, an influence attributable to interference from the second TRP 20 can be removed.

Furthermore, when the UE receives a PDCCH normally from at least one of a plurality of TRPs, it can receive a PDSCH normally based on the received PDCCH. Accordingly, the UE can obtain received data by demodulating and decoding the PDSCH. For example, if M TRPs have to transmit PDCCHs, a UE needs to monitor the PDCCHs from M BPLs. In this case, if only N PDCCHs smaller than M are received, the UE may receive a corresponding PDSCH using the received N PDCCHs, and may demodulate and decode the received PDSCH.

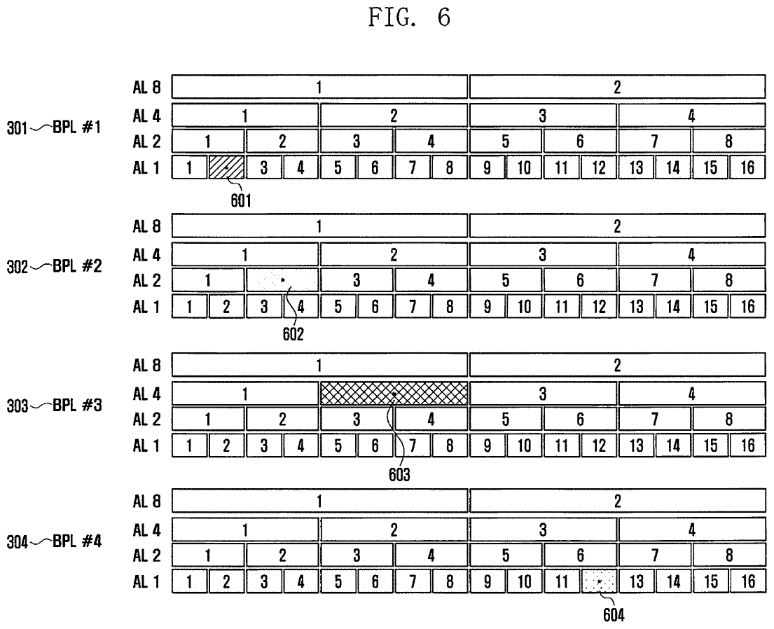

FIG. 6 is a diagram illustrating the resource locations of PDCCHs transmitted between different BPLs according to another embodiment of the disclosure.

FIG. 6 may be a form different from that of FIG. 5. That is, FIG. 5 corresponds to a case where all ALs are the same in different TRPs, but the example of FIG. 6 illustrates a case where ALs may be different.

FIG. 6 illustrates a case where a first TRP transmits a PDCCH at the No. 2 location 601 of an AL 1 in a BPL #1 301, a second TRP transmits a PDCCH at the No. 2 location 602 of an AL 2 in a BPL #2 302, a third TRP transmits a PDCCH at the No. 2 location 603 of an AL 4 in a BPL #3 303, and a fourth TRP transmits a PDCCH at the No. 12 location 604 of an AL 1 in a BPL #4 304.

In the example of FIG. 6, a case where the first TRP to the fourth TRP do not have a rule for transmitting a PDCCH in addition to an AL has been illustrated as an example. As described above, if a rule for an AL and a rule for determining the location of a PDCCH are not present, a UE cannot be aware that a corresponding TRP transmits a PDCCH at which location and using what AL if the UE does not receive a PDCCH from at least one of the first TRP to the fourth TRP.

Accordingly, in the disclosure, location information in another TRP and an AL may be configured in each PDCCH transmitted by each TRP. For example, the BPL #1 301 of the first TRP transmits a PDCCH at the No. 2 location 601 of the AL 1. In this case, the PDCCH may be transmitted, including location information of the BPLs of other TRPs, that is, location information and AL of a PDCCH transmitted in the BPL of the second TRP, location information and AL of a PDCCH transmitted in the BPL of the third TRP, and location information and AL of a PDCCH transmitted in the BPL of the fourth TRP.

That is, in the embodiment of FIG. 6, all of the first TRP to the fourth TRP need to provide location information and AL of a PDCCH transmitted in another TRP. Accordingly, resource allocation information of a PDSCH and information for demodulation and decoding have been merely transmitted in a previous PDCCH. In the disclosure, resource information of a PDCCH transmitted by another TRP is additionally transmitted.

This is described more specifically. In a conventional technology, assuming that resource allocation of a PDSCH and information transmitted for demodulation and decoding in a PDCCH are default control information, in the disclosure, AL information for the PDCCH of another TRP and additional control information for designating a location are further transmitted.

For example, the PDCCH of the first TRP may include default control information for a PDSCH transmitted by the first TRP, and AL information AL2 and location information (No. 2 location) of the PDCCH of the second TRP, AL information AL4 and location information (No. 2 location) of the PDCCH of the third TRP, and AL information AL1 and location information (No. 12 location) of the PDCCH of the fourth TRP as additional information. Furthermore, the PDCCH of the second TRP may include default control information for a PDSCH transmitted by the second TRP, and AL information AL1 and location information (No. 2 location) of the PDCCH of the first TRP, AL information AL4 and location information (No. 2 location) of the PDCCH of the third TRP, and AL information AL1 and location information (No. 12 location) of the PDCCH of the fourth TRP as additional information. In the same manner, the PDCCH of the third TRP may include default control information for a PDSCH transmitted by the third TRP, and AL information AU and location information (No. 2 location) of the PDCCH of the first TRP, AL information AL2 and location information (No. 2 location) of the PDCCH of the second TRP, and AL information AL1 and location information (No. 12 location) of the PDCCH of the fourth TRP as additional information. Furthermore, the PDCCH of the fourth TRP may include default control information for a PDSCH transmitted by the fourth TRP, and AL information AL1 and location information (No. 2 location) of the PDCCH of the first TRP, AL information AL2 and location information (No. 2 location) of the PDCCH of the second TRP, and AL information AL4 and location information (No. 2 location) of the PDCCH of the third TRP as additional information.

As described above, the additional information may further include additional information for designating PDCCH locations corresponding to a number that is 1 smaller than the number of BPLs to be monitored by a UE. Accordingly, if a UE has to monitor 2 BPLs, additional information included in each PDCCH may be AL information and location information of one PDCCH.

Furthermore, in the above example, separate identification information for identifying each TRP may be further included. That is, the first TRP may include identification information of the second TRP along with PDCCH location information of the second TRP. Accordingly, a UE that receives the same data from three or more TRPs can identify each of the TRPs, and can also be aware of location information of the PDCCH of the identified TRP.

If a UE obtains a PDCCH in at least one of a plurality of BPLs through the aforementioned method, the removal of interference attributable to a carrier received from an adjacent TRP can be facilitated. For example, there may be a case where a UE receives a PDCCH normally from the first TRP 10 and does not receive a PDCCH from the second TRP 20. In such a case, the UE can be aware of the location of the PDCCH received from the second TRP 20. Accordingly, an influence attributable to interference from the second TRP 20 can be removed based on the location of the PDCCH received from the second TRP 20.

Furthermore, when the UE receives a PDCCH normally from at least one of a plurality of TRPs, it can receive a PDSCH normally based on the received PDCCH. Accordingly, the UE can obtain received data by demodulating and decoding the PDSCH. For example, if M TRPs transmit PDCCHs, a UE needs to monitor the PDCCHs from M BPLs. In this case, if only N PDCCHs smaller than M are received, the UE may receive a corresponding PDSCH using the received N PDCCHs, and may demodulate and decode the received PDSCH.

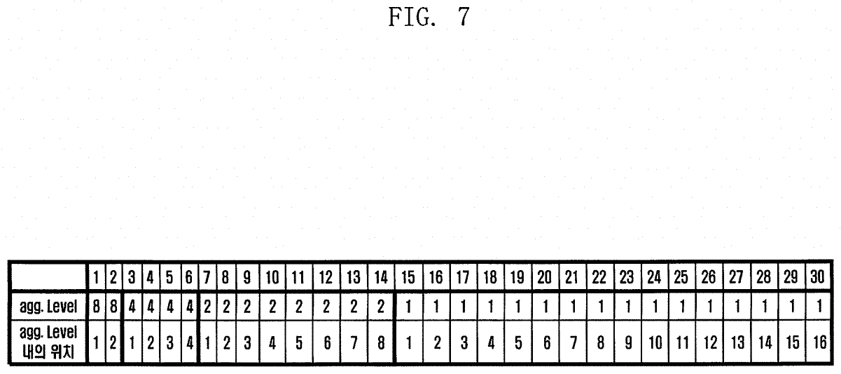

In the method of FIG. 6, information that needs to be transmitted in a PDCCH may be increased because an AL and the location of the AL need to be separately designated. Accordingly, in order to transmit the information more easily, if the AL and the location are mapped and mapped information is used as in FIG. 7, the AL of an adjacent base station and/or TRP and the transmission location of a PDCCH can be easily determined. That is, the AL of an adjacent base station and/or TRP and the transmission location of a PDCCH can be configured in a UE using a joint coding method.

FIG. 7 is an exemplary diagram for describing the mapping of an aggregation level and location information of a PDCCH according to an embodiment of the disclosure.

FIG. 7 may be an example of a joint coding method. FIG. 7 is described along with FIG. 6, for convenience of understanding. In FIG. 7, an agg. Level means an aggregation level. Accordingly, an aggregation level may include the case of 8 and the case of 4, and the case of 2 and the case of 1.

Furthermore, a location within the agg. Level means a location according to an aggregation level. For example, the case of the BPL #1 in FIG. 6 is described. The AL 8 may have two locations of 1 and 2. Accordingly, in FIG. 7, in an agg. Level 8, locations within the agg. Level has been classified into 1 and 2. Each of 1 and 2 above the agg. Level 8 may be one value for designating each of 1 and 2.

Furthermore, the AL 4 may have four locations of 1 to 4. Accordingly, in FIG. 7, in an agg. Level 4, locations within the agg. Level has been classified into 1 to 4. Each of 3 to 6 above the agg. Level 4 may be one value for designating each of 3 to 6. Likewise, the AL 2 may have 8 locations of 1 to 8. Accordingly, in FIG. 7, in an agg. Level 2, locations within the agg. Level has been classified into 1 to 8. Each of 7 to 14 above the agg. Level 2 may be one value for designating each of 7 to 14. Finally, the AL 1 may have 16 locations of 1 to 16. Accordingly, in FIG. 7, in an agg. Level 1, locations within the agg. Level have been classified into 1 to 16. Each of 15 to 30 above the agg. Level 1 may be one value for designating each of 15 to 30.

If locations and ALs have four types as described above, in order to designate the ALs and locations, the AL and location of another TRP may be designated using only a total of 5 bits. Such information may have been previously agreed between a base station and a UE or a base station may transmit such information to a UE through high signaling or L1 signaling.

Accordingly, according to the example of FIG. 7, the transmission location and AL of the PDCCH of the first TRP may be designated as a value of 16. According to the example of FIG. 7, the transmission location and AL of the PDCCH of the second TRP may be designated as a value of 8. The transmission location and AL of the PDCCH of the third TRP may be designated as a value of 4. The transmission location and AL of the PDCCH of the fourth TRP may be designated as a value of 26.

Accordingly, the case of FIG. 6 is described again. The PDCCH of the first TRP may include default control information for a PDSCH transmitted by the first TRP, and a value of “8” set to designate the AL information AL2 and location information (No. 2 location) of the PDCCH of the second TRP, a value of “4” set to designate the AL information AL4 and location information (No. 2 location) of the PDCCH of the third TRP, and the AL information AL1 and location information (No. 12 location) of the PDCCH of the fourth TRP set to designate a value of “26” as additional information. Furthermore, the PDCCH of the second TRP may include default control information for a PDSCH transmitted by the second TRP, and a value of “16” set to designate the AL information AL1 and location information (No. 2 location) of the PDCCH of the first TRP, a value of “4” set to designate the AL information AL4 and location information (No. 2 location) of the PDCCH of the third TRP, and a value of “26” set to designate the AL information AL1 and location information (No. 12 location) of the PDCCH of the fourth TRP as additional information. In the same manner, the PDCCH of the third TRP may include default control information for a PDSCH transmitted by the third TRP, and a value of “16” set to designate the AL information AL1 and location information (No. 2 location) of the PDCCH of the first TRP, a value of “8” set to designate the AL information AL2 and location information (No. 2 location) of the PDCCH of the second TRP, and a value of “26” set to designate the AL information AL1 and location information (No. 12 location) of the PDCCH of the fourth TRP as additional information. Finally, the PDCCH of the fourth TRP may include default control information for a PDSCH transmitted by the fourth TRP, and a value of “16” set to designate the AL information AL1 and location information (No. 2 location) of the PDCCH of the first TRP, a value of “8” set to designate the AL information AL2 and location information (No. 2 location) of the PDCCH of the second TRP, and a value of “4” set to designate the AL information AL4 and location information (No. 2 location) of the PDCCH of the third TRP as additional information.

The joint coding method has been described above as a method for designating the AL and location of a PDCCH transmitted by another TRP and/or base station in a PDCCH transmitted in one BPL.

Hereinafter, a method for designating the AL and location of a PDCCH transmitted by another TRP and/or base station in a PDCCH transmitted in one BPL in a bitmap form, that is, a method different from the aforementioned method is described.

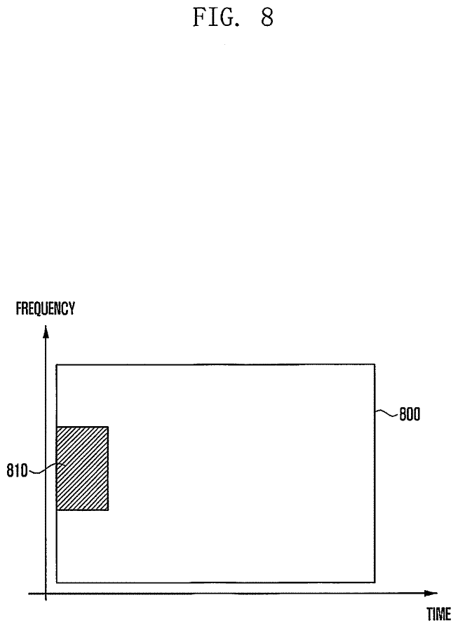

FIG. 8 is a diagram illustrating a downlink resource including a CORESET resource in one base station or TRP of a 5G communication system according to an embodiment of the disclosure.

Referring to FIG. 8, it can be seen that only some frequency/time resource of the entire downlink frequency/time resource 800 is allocated as a CORESET resource 810. Accordingly, all UEs need to monitor the CORESET resource 810 transmitted by a base station or TRPs. In general, a region except such a CORESET resource 810 may be a downlink resource for transmitting user data.

As illustrated in FIG. 8, a PDCCH in which data to be transmitted to each UE, that is, resource allocation information of data to be transmitted in a PDSCH and information necessary for the demodulation and decoding of the data, may be transmitted in the CORESET resource 810. Furthermore, as illustrated in FIG. 8, it may be seen that the CORESET resource 810 is allocated to only some resource of the entire frequency/time resource. Accordingly, in addition to the aforementioned method, the CORESET resource 810 may be divided in a given resource unit, and the divided resources may be identified in a bitmap form. That is, the physical locations of the CORESET resource 810 transmitted by respective TRPs and/or base stations may be divided in a bitmap form.

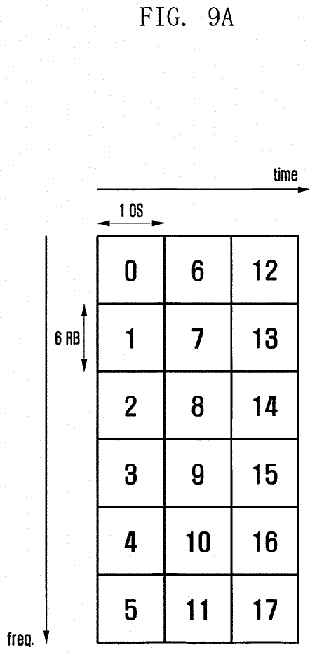

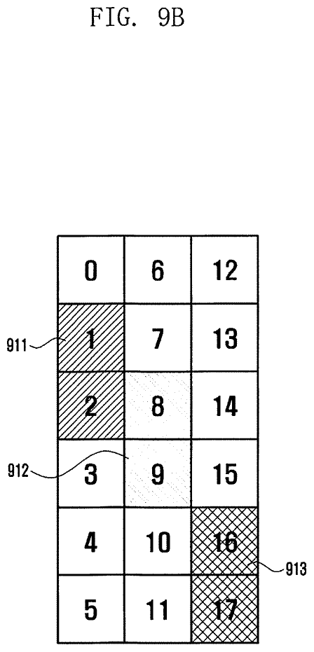

FIGS. 9A and 9B are exemplary diagrams in which a CORESET resource is divided in a bitmap form according to an embodiment of the disclosure.

First, FIG. 9A illustrates a case where one resource block has the size of one OFDM symbol in a time axis and has 6 resource block (RBs) in a frequency axis. As described above, assuming that a unit including one OFDM symbol in the time axis and 6 RBs in the frequency axis is a PDCCH allocation unit, a base station may assign one identification number to each PDCCH allocation unit. FIG. 9A illustrates a form in which an identification number of “0” has been assigned to an RB having the highest frequency in the first OFDM symbol period of a CORESET resource and identification numbers of 1, 2, 3, 4, and 5 have been assigned to lower frequencies in the same first OFDM symbol period. Accordingly, a total of 6 PDCCH allocation units are present in the first OFDM symbol period. Likewise, in a next OFDM symbol period, a total of 6 PDCCH allocation units are present. A method of assigning the identification numbers is the same. This corresponds to a form in which an identification number of “6” has been assigned to an RB having the highest frequency and identification numbers of 7, 8, 9, 10, and 11 have been assigned to lower frequencies because the assignment of the numbers starts at the location of the second OFDM symbol.

In the embodiment of the disclosure, 6 RBs have been illustrated as being one PDCCH allocation unit in the frequency axis, but the number of RBs may be adjusted if necessary. For example, the number of RBs may be set in various forms, such as 1, 2, 4, 5, 8 or 10. Such setting may be pre-defined and may be a value known to both a UE and a base station.

Likewise, even in the third OFDM symbol period, a total of 6 PDCCHs allocation units are present, and a method of assigning identification numbers is the same. This corresponds to a form in which an identification number of “12” has been assigned to an RB having the highest frequency and identification numbers of 13, 14, 15, 16, and 17 have been assigned to lower frequencies because the assignment of the numbers starts at the location of the third OFDM symbol.

Next, FIG. 9B illustrates a method of allocating a PDCCH resource in the BPL of each TRP and designating the location of a PDCCH transmitted by another TRP and/or base station in a PDCCH transmitted to a UE in a BPL through the bitmap of the allocated resource.

Reference number 911 is assumed to be a case where a PDCCH is transmitted in the BPL of a first TRP. Reference number 912 is assumed to be a case where a PDCCH is transmitted in the BPL of a second TRP. Reference number 913 is assumed to be a case where a PDCCH is transmitted in the BPL of a third TRP. Accordingly, the first TRP may transmit the PDCCH through second and third high frequency bands at the location of reference number 911, that is, at the location of the first OFDM symbol in a time axis. In this case, location information of the PDCCH transmitted in the BPL of the second TRP and location information of the PDCCH transmitted in the BPL of the third TRP may be transmitted in the PDCCH transmitted in the BPL of the first TRP in a bitmap form. That is, in the PDCCH transmitted in the BPL of the first TRP, the location of each of the location information of the PDCCH transmitted in the BPL of the second TRP and the location information of the PDCCH transmitted in the BPL of the third TRP may be set to “1” or “0”, and values of the remaining regions may be inverted. If a UE is notified of the transmission of the PDCCH transmitted by the second TRP using a value of “1”, such notification may be set like “000000 001100 000000” and transmitted. In this case, the foremost “000000” indicates whether the PDCCH is transmitted using the value of “0” or “1” in each allocation unit of the PDCCH at the location of the first OFDM symbol.

Furthermore, if all of different TRPs transmit all PDCCHs at different locations, PDCCH location information of all of the TRPs may be notified using one piece of bitmap information, that is, only a 16-digit bit. In such a case, referring to FIG. 9B, a PDCCH transmission location transmitted in the BPL of the first TRP may be “011000”, a PDCCH transmission location transmitted in the BPL of the second TRP may be “001100”, and a PDCCH transmission location transmitted in the BPL of the third TRP may be “000011.” Accordingly, all of the TRPs may set the entire bitmap of the PDCCHs transmitted in the BPLs like “011000001100000011” and transmit the bitmap.

FIG. 10 is a control flowchart upon downlink transmission by each TRP and/or base station according to the disclosure.

In the following description, a case where a control operation is performed in a TRP although the control operation is actually performed in a base station is assumed and described, for convenience of description.

Referring to FIG. 10, at operation 1000, a TRP allocates a resource to data to be transmitted to a UE. This may be a case where scheduling for transmitting data is performed if user data or given control data to be transmitted from a TRP to a UE is received from a higher network or a base station.

Thereafter, at operation 1010, the TRP configures a PDCCH and a PDSCH based on the results of the scheduling. In this case, the PDCCH may use one of the aforementioned methods. That is, the PDCCH may include location information of a PDCCH between TRPs. Furthermore, in an embodiment in which all the transmission locations of PDCCH are the same for each TRP or an embodiment having a given rule, a rule or location information may be previously transmitted through high signaling (not illustrated in FIG. 10). In contrast, if the transmission locations and/or ALs of PDCCHs are different for each TRP, the TRP may configure location information and/or AL information of the PDCCHs transmitted in the BPLs of other TRPs so that they are included. The aforementioned embodiments may be used for such a configuration of information.

Furthermore, as described above, a PDSCH may invade a PDCCH region, and may transmit data. If the PDSCH overlaps the PDCCH, the data may be removed from the period of the PDCCH, and rate matching may be performed as much as the removed data and the data may be configured.

At operation 1010, when the configuration of the PDCCH and the PDSCH is completed, the TRPs may perform the downlink transmission operation at operation 1020.

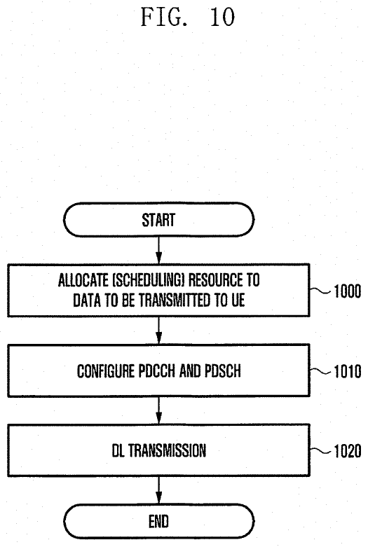

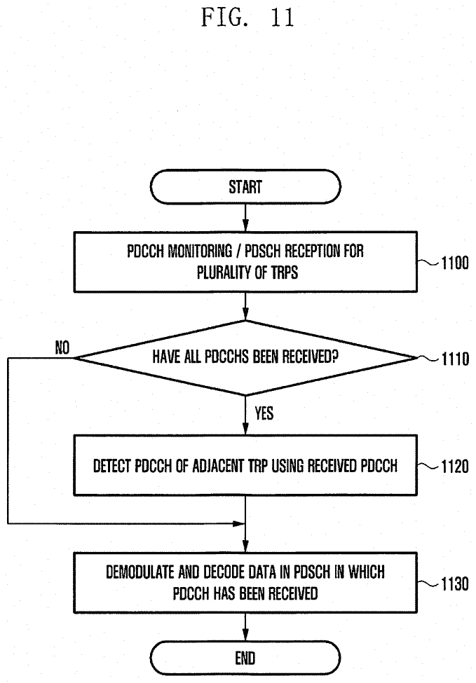

FIG. 11 is a control flowchart when a UE receives a PDCCH and PDSCH from a plurality of TRPs according to the disclosure.

As described above, FIG. 11 is an embodiment of a case where all of a plurality of TRPs transmits the same data to one UE.

Referring to FIG. 11, at operation 1100, the UE may monitor a PDCCH for the plurality of TRPs and receive a PDSCH. In this case, information that enables the plurality of TRPs to monitor the PDCCH may be previously received through high signaling (not illustrated in FIG. 11).

When the UE receives at least one PDCCH from the plurality of TRPs at operation 1100, the UE may proceed to operation 1110 in which the UE may check whether all PDCCHs have been received. For example, if PDCCHs have been configured to be received through BPLs from a first TRP and a second TRP, the UE may check whether it has received the PDCCHs from the first TRP and the second TRP at operation 1110.

If all of the PDCCHs have been received as a result of the check at operation 1110, that is, if the PDCCHs have been received through the BPLs from the first TRP and the second TRP, the UE may proceed to operation 1130. In contrast, if a PDCCH has not been received through the BPL of at least one TRP, the UE may proceed to operation 1120.

At operation 1120, the UE may detect the locations of PDCCHs of an adjacent TRPs using the received PDCCH. That is, as in the aforementioned embodiments, the UE may detect the locations and ALs of the PDCCHs of adjacent TRPs in additional information included in the PDCCH using at least one of a joint coding method or a bitmap method or a method of directly indicating location and AL information. Furthermore, if a rule is pre-configured and all locations are the same through high signaling or a given rule is present, at operation 1120, the UE may apply the corresponding rule to operation 1130.

When the UE proceeds to operation 1130, if the UE receives all the PDCCHs and proceeds to operation 1130, the UE may demodulate and decode a PDSCH based on the received PDCCH. In contrast, if the UE has not received a PDCCH that needs to be transmitted through the BPL of at least one TRP, a method of the UE may be divided into the two methods as described above.

If the PDCCH has an association of a given rule, the UE may obtain location and/or AL information of a PDCCH received from an adjacent TRP based on the corresponding association rule, and may perform the interference removal of TRPs from which PDCCHs and PDSCHs have been received normally and data demodulation using the location and/or AL information. In contrast, if the PDCCH does not have an association of a given rule, the UE may obtain location and/or AL information of a PDCCH transmitted by an adjacent TRP using information included in the received PDCCH, and may perform the interference removal of TRPs from which PDCCHs and PDSCHs have been received normally and data demodulation using the location and/or AL information.

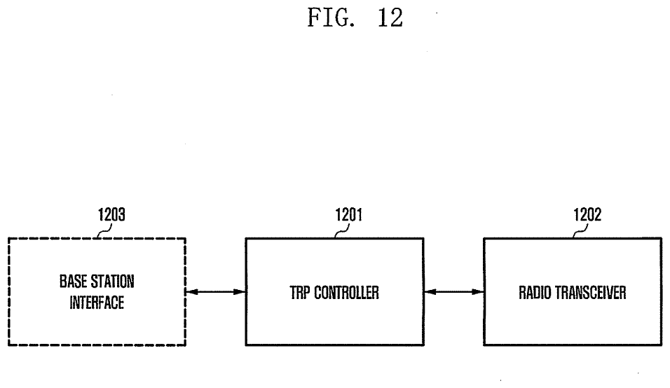

FIG. 12 is a functional block diagram of a TRP according to the disclosure.

A functional operation of a TRP according to the disclosure is described with reference to FIG. 12. Referring to FIG. 12, the TRP may include a TRP controller 1201, a radio transceiver 1202, and a base station interface 1203.

FIG. 12 illustrates the case of a TRP, but the TRP may be substituted with a base station if necessary in the case of a description in the entire specification. Accordingly, if the TRP is a base station, the base station interface 1203 may be a high network interface and an adjacent base station network interface. Furthermore, although not illustrated in FIG. 121 the TRP and/or the base station may further include a memory. The base station interface 1203 may receive data to be transmitted from the base station to a UE and control information necessary for the transmission of the data. Furthermore, if the TRP is a base station, the base station interface 1203 may be a high network interface and an adjacent base station network interface, and may receive data to be transmitted from a network to a UE and control information necessary for the transmission of the data.

The TRP controller 1201 may encode and modulate data to be transmitted, and may output a reference signal according to the disclosure to the radio transceiver 1202 by mapping the reference signal to a desired location along with data or separately from the data. Furthermore, the TRP controller 1201 may generate location information and/or AL information of the PDCCH of an adjacent TRP, and may transmit it to a UE 201. Furthermore, such information may use high signaling or another piece of signaling information, and may be included in a PDCCH. Furthermore, the TRP controller 1201 may determine a beam to be used. Furthermore, the TRP controller 1201 may control various required operations that have been described above. The TRP controller 1201 may be configured with a single processor or may be configured with two or more processors.

The radio transceiver 1201 may perform operations of low-noise-amplifying a signal received from an antenna, band-down-converting the signal into a baseband, and converting an analog signal into a digital signal through demodulation and decoding. The radio transceiver 1201 may provide the TRP controller 1201 with the information or signal converted into the digital signal as described above. Furthermore, the radio transceiver 1201 may receive a signal fed backed by a UE, and may provide the TRP controller 1201 with the signal as a digital signal. Furthermore, the radio transceiver 1201 may up-convert and power-amplify a signal to be transmitted into a frequency band operating in a system, and may transmit the signal to a UE through one or two or more antennas. That is, the radio transceiver 1201 may transmit, to the UE, a high layer signaling signal, a PDCCH and a PDSCH using at least one beam as described above.

As described above, the TRP may further include a memory. The memory may store various data necessary for the TRP, and various pieces of information, such as configuration information of each UE, base station beam information, and UE bean information. It is to be noted that the block diagram of the TRP illustrated in FIG. 12 according to the disclosure is not specially limited to such a formal aspect and is merely a block diagram in a functional aspect.

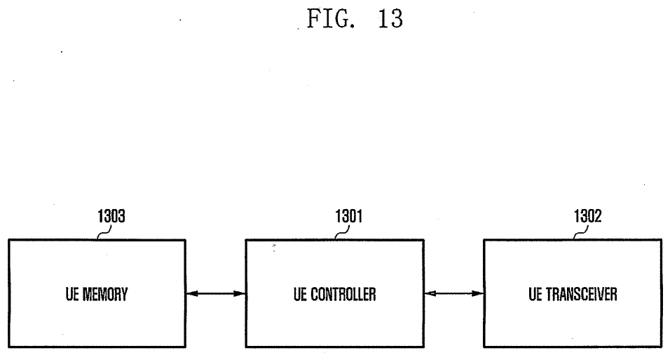

FIG. 13 is a major block diagram of a terminal apparatus according to an embodiment of the disclosure.

Referring to FIG. 13, the terminal apparatus may include a UE controller 1301, a UE transceiver 1302 and a UE memory 1303.

The UE controller 1301 may perform an overall operation for the reception of a signal according to the disclosure. Particularly, the UE controller 1301 may perform a control operation as described above. That is, the UE controller 1301 monitors a PDCCH through the BPLs of a plurality of TRPs, and may perform an operation of receiving and processing data if at least one of PDCCHs that are monitored is received. The UE controller 1301 may be configured with a single processor or may be configured with two or more processors. For example, the UE controller may be configured with an application processor and a communication processor, which may perform respective functional operations.

The UE transceiver 1302 may receive the aforementioned signals through a preset band, and may down-band-convert and output the signals. That is, the UE transceiver 1302 may receive a high layer signal, control message, PDCCH and/or PDSCH received from a base station and/or TRPs, may band-down-convert and demodulate and decode them, and may provide it to the UE controller 1301 as a digital signal. Furthermore, the UE transceiver 1302 may receive a downlink signal through the BPL of the aforementioned embodiments, and may provide the UE controller 1301 with corresponding results as a digital value. Furthermore, the UE transceiver 1302 may band-up-convert signals to be transmitted, and may transmit them to a base station and/or TRPs through an antenna (not illustrated).

The UE memory 1303 may store pieces of information signaled by a base station, and may store location information of a PDCCH, PDCCH transmission rule information of each TRPs, AL information, etc. Furthermore, the UE memory 1303 may store pieces of information and/or pieces of information for a control operation described in the above embodiments.

It is to be noted that FIG. 8 has illustrated only the elements necessary to describe the disclosure and other elements have been omitted.

Furthermore, the embodiments disclosed in this specification and drawings propose only specific examples in order to easily describe the contents of the disclosure and help understanding, and the embodiments are not intended to restrict the scope of rights of the disclosure. Accordingly, it should be understood that all modifications or variations derived based on the technical spirit of the disclosure in addition to the disclosed embodiments should be construed as being included in the disclosure.

### INDUSTRIAL APPLICABILITY

The disclosure may be used for a case where the same data is transmitted and received from two or more transmission apparatuses to one reception apparatus.

1. A method for transmitting data from two or more transmission points under one base station to a terminal in a wireless communication system,
wherein each of the transmission points comprises:
allocating a first resource for transmitting identical data to the terminal,
configuring first control information for a restoration of the first resource,
transmitting, to the terminal, the first control information, first additional information and the data through a beam pair link (BPL) set up with the terminal, and
wherein the first additional information includes resource information of information, transmitted by at least another transmission point transmitting the identical data and corresponding to the first control information.

2. The method of claim 1, wherein the resource information includes at least one of location information and aggregation level (AL) of the first control information.

3. The method of claim 1, wherein the first additional information further includes identification information for identifying the transmission point.

4. The method of claim 1, wherein the resource information is provided through bit mapping in a pre-configured region of a control resource set (CORESET).

5. A data transmission apparatus in a wireless communication system, wherein a transmission point apparatus for transmitting data to a terminal comprises:
a base station interface receiving, from a base station, data and a control signal to be provided to the terminal;
a radio transceiver transmitting the data and the control signal to the terminal; and
a transmission and reception point controller configured to allocate a first resource for transmitting the data to the terminal, configure first control information for a restoration of the first resource, and control the radio transceiver to transmit, to the terminal, the first control information, first additional information and the data through a beam pair link (BPL) set up with the terminal,
wherein the first additional information includes resource information of information, transmitted by at least another transmission point transmitting identical data and corresponding to the first control information.

6. The data transmission apparatus of claim 5, wherein the resource information includes at least one of location information and aggregation level (AL) of the first control information.

7. The data transmission apparatus of claim 5, wherein the first additional information further includes identification information for identifying the transmission point.

8. The data transmission apparatus of claim 5, wherein the resource information is provided through bit mapping in a pre-configured region of a control resource set (CORESET).

9. A method for receiving data from a first transmission point and a second transmission point under one base station in a wireless communication system, the method comprising:
monitoring a reception of first control information and a first data channel through a beam pair link (BPL) set up with the first transmission point;
monitoring a reception of second control information and a second data channel through a BPL set up with the second transmission point;
identifying whether the second control information is received;
detecting the second control information using the first information based on the second control information being not received; and
demodulating and decoding received data based on information received in the first data channel and the second data channel,
wherein the first control information includes resource information of the second control information transmitted by the at least second transmission point.

10. The method of claim 9, wherein the resource information includes at least one of location information and aggregation level (AL) of the second control information.

11. The method of claim 9, wherein the first additional information further includes identification information for identifying the transmission point.

12. The method of claim 9, wherein the resource information is received in a pre-configured region of a control resource set (CORESET) through bit mapping.

13. A data reception apparatus in a wireless communication system, wherein a terminal apparatus for receiving data from two or more transmission points comprises:
a transceiver receiving a first control signal and a first data channel through a beam pair link (BPL) set up with a first transmission point and receiving a second control signal and a second data channel through a beam pair link (BPL) set up with a second transmission point;
a controller configured to monitor the reception of the first control information and first data channel and the second control information and second data channel received from the transceiver, identify whether the second control information is received, detect the second control information using the first information based on the second control information being not received, and control a demodulation and decoding of data received in the first data channel and the second data channel through the transceiver,
wherein the first control information includes resource information of the second control information transmitted by the at least second transmission point.

14. The data reception apparatus of claim 13, wherein the resource information includes at least one of location information and aggregation level (AL) of the second control information and is received through bit mapping in a pre-configured region of a control resource set (CORESET).

15. The data reception apparatus of claim 13, wherein the first control information further comprises identification information for identifying the second transmission point.
